(19) United States
(12) Patent Application Publication
(10) Pub. No.: US 2010/0117594 A1
(43) Pub. Date: May 13, 2010

(54) STRATEGY FOR MAINTAINING STATE OF CHARGE OF A LOW-VOLTAGE BATTERY BANK IN A HYBRID ELECTRIC VEHICLE HAVING A HIGH-VOLTAGE TRACTION BATTERY BANK

(75) Inventor: Jay E. Bissontz, Fort Wayne, IN (US)

Correspondence Address: International Truck Intellectual Property Company,, 4201 WINFIELD ROAD, WARRENVILLE, IL, 60555, US

(73) Assignee: International Truck Intellectual Property Company, LLC, Warrenville, IL (US)

(21) Appl. No.: 12/270,565

(22) Filed: Nov. 13, 2008

(51) Int. Cl. H02J 7/00; H02J 7/04

(52) U.S. Cl. 320/104; 320/157; 903/907

(57) ABSTRACT

A hybrid electric motor vehicle (12) has a combustion engine (14), a high-voltage battery bank (28), a low-voltage battery bank (30), an electric generator (32) driven by engine (14) for recharging battery bank (30), a DC-to-DC converter (46) for recharging battery bank (30) from battery bank (28), a monitor for indicating voltage of battery bank (30), a recharge initiate timer that, while battery bank (28) and not generator (32) is recharging battery bank (30) via converter (46), is started by the monitor indicating that voltage of battery bank (30) is below a recharge initiate threshold and whose rate of timing is a function of voltage indicated by the monitor as the timer times. If the timer times to a recharge initiate limit, the generator begins recharging battery bank (30).

### TECHNICAL FIELD

The technical field of this patent application concerns hybrid electric vehicles of the type in which the propulsion system comprises a combustion engine associated with an electric motor/generator that at times operates as a traction motor for propelling the vehicle and at times as a generator for maintaining state-of-charge (SOC) of a high-voltage traction battery bank. More particularly, the disclosure of this patent application relates to a strategy for recharging a low-voltage battery bank, typically a nominal 12-volt or 24-volt DC battery bank that unlike the traction battery bank, isn't used to propel the vehicle, when for whatever reason, the traction battery bank, acting through a DC-to-DC converter, becomes unable to maintain SOC of the low-voltage battery bank.

### BACKGROUND OF THE DISCLOSURE

A hybrid electric vehicle whose propulsion system comprises an electric motor/generator associated with a combustion engine can operate with significantly greater fuel economy in comparison to a corresponding vehicle that is propelled only by a combustion engine because at certain times during operation of the vehicle, such as during vehicle braking for example, the motor/generator recovers kinetic energy from the vehicle by operating as a generator that generates electric current for recharging a high-voltage traction battery bank, and at other times during operation of the vehicle, the motor/generator operates as a traction motor that draws electric current from the traction battery bank to propel the vehicle either by itself, or to add additional torque to that being produced by the combustion engine. Because of the fuel economy improvements that can result, the added cost of such a propulsion system can have favorable cost implications for users such as commercial truckers.

The development of some hybrid electric vehicles begins by integrating a motor/generator with the powertrain of a more conventional motor vehicle that is propelled by an internal combustion engine, either gasoline or diesel. The existing electrical system of such a vehicle is a low-voltage one, such as a 12-volt DC system, that serves the electrical demands of many electrical devices in the vehicle. The battery bank of a low-voltage electrical system comprises one or more DC storage batteries whose SOC is maintained by an alternator that is driven by the engine when the engine runs.

Because a low-voltage motor/generator is generally considered unsuitable for use as a traction motor of a hybrid electric vehicle, the design of such a vehicle is predicated on the addition of a high-voltage electrical system, thereby endowing the vehicle with separate electrical systems, the usual low-voltage one and the additional high-voltage one.

The high-voltage electrical system comprises a high-voltage traction battery bank whose voltage can range as high as about 600 volts DC, with a 340-volt DC system being one example.

Certain non-hybrid vehicles depend on the low-voltage battery bank to operate certain accessory equipment when the vehicle is parked with the engine not running. In order to maintain SOC of the low-voltage battery bank because of the accessory load, the alternator may be operated by running the engine.

While the same may be true for a hybrid electric vehicle, the presence of a high-voltage traction battery bank provides an additional, and larger, source of energy that is available to operate the accessory equipment. Consequently the low-voltage and the high-voltage electrical systems may associated through a DC-to-DC converter that utilizes the SOC of the traction battery bank to maintain SOC of the low-voltage battery bank when the engine is shut off and low-voltage electrical accessory equipment is in use. One example of such accessory equipment is an electric power take-off (ePTO).

### SUMMARY OF THE DISCLOSURE

Because the applicant has recognized the possibility that the high-voltage electrical system may, for whatever reason, become unable to maintain SOC of the low-voltage battery bank and that depletion of low-voltage battery bank SOC below some threshold level can begin to impact battery bank life and/or operation of accessories that are drawing electricity from the battery bank, this disclosure presents a solution for anticipating such depletion and taking steps to avoid it.

A hybrid electric motor vehicle comprises a combustion engine, a high-voltage electrical system comprising a high-voltage battery bank, a low-voltage electrical system comprising a low-voltage battery bank, an electric generator driven by the engine for recharging the low-voltage battery bank, a DC-to-DC converter for recharging the low-voltage battery bank from the high-voltage battery bank, a monitor for indicating voltage of the low-voltage battery bank, a recharge initiate timer that, while the high-voltage battery bank and not the generator is recharging the low-voltage battery bank via the DC-to-DC converter, is started by the monitor indicating that voltage of the low-voltage battery bank is below a recharge initiate threshold and whose rate of timing is a function of voltage indicated by the monitor as the timer times. If the timer times to a recharge initiate limit, the generator begins recharging the low-voltage battery bank.

A method for recharging a low-voltage battery bank of a low-voltage electrical system in a hybrid electric vehicle whose propulsion system comprises an electric motor/generator associated with a combustion engine such that at certain times during operation of the vehicle, the motor/generator recovers kinetic energy from the vehicle by operating as a generator that generates electric current for recharging a high-voltage traction battery bank in a high-voltage electrical system of the vehicle, and at other times during operation of the vehicle, the motor/generator operates as a traction motor that draws electric current from the traction battery bank to propel the vehicle either by itself, or to add additional torque to that being produced by the combustion engine The vehicle further comprises an electric generator driven by the engine and a DC-to-DC converter through which the low-voltage battery bank is recharged by the high-voltage battery bank.

The method comprises monitoring voltage of the low-voltage battery bank and when the monitored voltage is below a recharge initiate threshold, while the high-voltage battery bank and not the generator is recharging the low-voltage battery bank via the DC-to-DC converter, starting a recharge initiate timer and as the timer times, controlling the timer's rate of timing as a function of monitored voltage. Once the timer has timed to a recharge initiate limit, the generator is caused to begin recharging the low-voltage battery bank.

The foregoing summary, accompanied by further detail of the disclosure, will be presented in the Detailed Description below with reference to the following drawings that are part of this disclosure.

### BRIEF DESCRIPTION OF THE DRAWINGS

FIG. 1 is a schematic diagram of a representative propulsion system of a hybrid electric vehicle.

FIG. 2 is a schematic wiring diagram of portions of high- and low-voltage electrical systems in the hybrid electric vehicle.

FIGS. 3A and 3B collectively comprise a strategy diagram that embodies the aforementioned solution.

### DETAILED DESCRIPTION

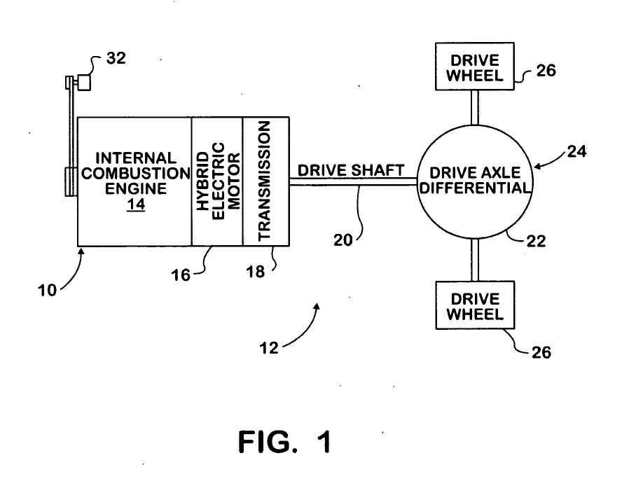

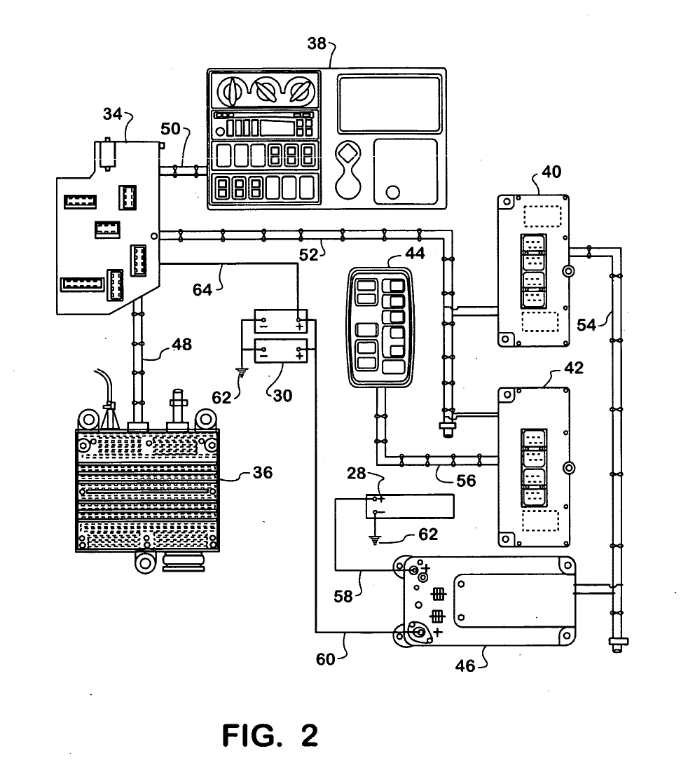

FIG. 1 shows a portion of an exemplary propulsion system 10 of a hybrid electric vehicle 12 as background for ensuing explanation of the other Figures. Not all mechanical detail of propulsion system 10 is shown. Vehicle 12 is shown, by way of example, as a rear wheel drive type vehicle, in which propulsion system 10 is configured such that an output shaft of an internal combustion engine 14 and a rotor of a rotary DC electrical machine (i.e. a motor/generator) 16 are suitably coupled to an input shaft of a transmission 18 such that either or both engine 14 and motor/generator 16 can propel vehicle 12 via a drivetrain in which an output of transmission 18 is coupled via a driveshaft 20 to a differential 22 of a rear axle 24 having wheels 26 attached to outer ends of respective shafts, and such that when kinetic energy of the vehicle is to be recovered, the drivetrain can operate motor/generator 16 as a generator to re-charge a high-voltage traction battery bank 28 (FIG. 2) that stores the recovered energy for later use in operating motor/generator 16 as a motor.

Battery bank 28 is a constituent of a high-voltage electrical system (negative ground, 340 VDC for example) in vehicle 12. A low-voltage electrical system (negative ground, 12 VDC for example) in vehicle 12 comprises a low-voltage battery bank 30 (FIG. 2) of one or more batteries whose SOC is maintained by an alternator 32 (FIG. 1), or any equivalent electric generator, that is driven by engine 14 through any suitable coupling such as a belt and sheaves to generate electricity for keeping battery bank 30 properly charged.

FIG. 2 shows an electronic system controller (ESC) 34, a remote power module (RPM) 36, an in-cab dash panel 38, a hybrid control module (HCM) 40, a transmission control module (TCM) 42, a push button shift console 44, and a DC-to-DC converter 46.

A CAN (computer area network) data link 48 provides a data communication path between ESC 34 and RPM 36. A CAN data link 50 provides a data communication path between ESC 34 and various controls and displays of dash panel 38. A CAN data link 52 provides a data communication path between ESC 34 and both HCM 40 and TCM 42. A CAN data link 54 provides a data communication path between HCM 40 and DC-to-DC converter 46. A CAN data link 56 provides a data communication path controls of shift console 44 and TCM 42.

ESC 34 is in a low-voltage electrical system of vehicle 12 and controls and monitors various aspects of vehicle operation including engine 14. The controls and displays of dash panel 38 are also in the low-voltage system. Communication among ESC 34, dash panel 38, HCM 40, TCM 42, and controls of shift console 44 provides for coordinated control of propulsion system 10 to propel vehicle 12 by engine 14 operating alone, by motor/generator 16 operating alone, or by motor/generator 16 operating to supplement operation of engine 14, while enabling kinetic energy of vehicle 12 to be recovered and re-used via motor/generator 16 in conjunction with high-voltage battery bank 28.

DC-to-DC converter 46 has an input coupled to high-voltage battery bank 28 and an output coupled to low-voltage battery bank 30. FIG. 2 shows a cable 58 running from a positive terminal of battery bank 28 to a positive input terminal of DC-to-DC converter 46 and a cable 60 running from a positive output terminal of converter 46 to a positive terminal of battery bank 30. Both battery banks are commonly grounded to a ground 62. Voltage of battery bank 30 can be monitored by ESC 34 in any suitably appropriate way, such as by a direct connection 64.

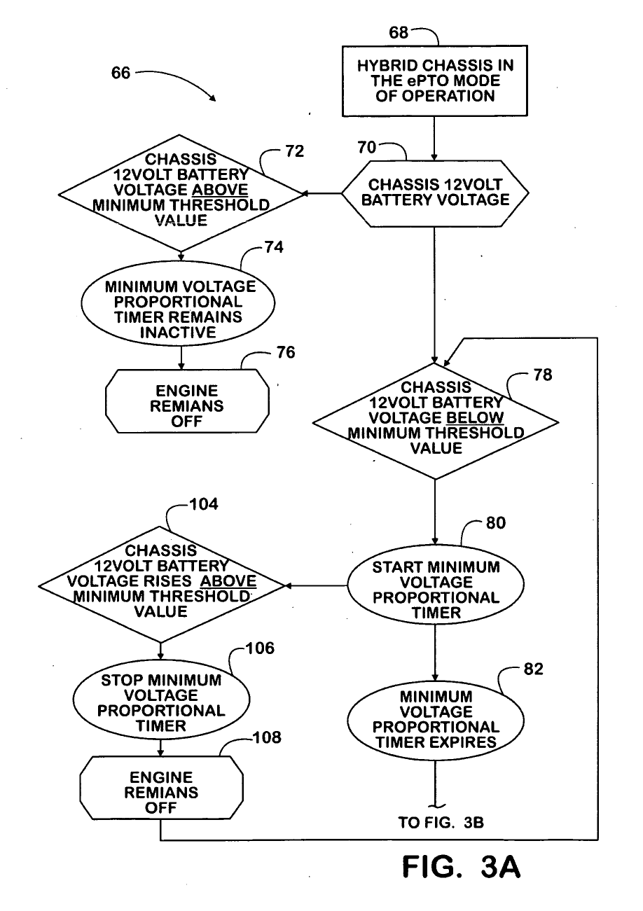

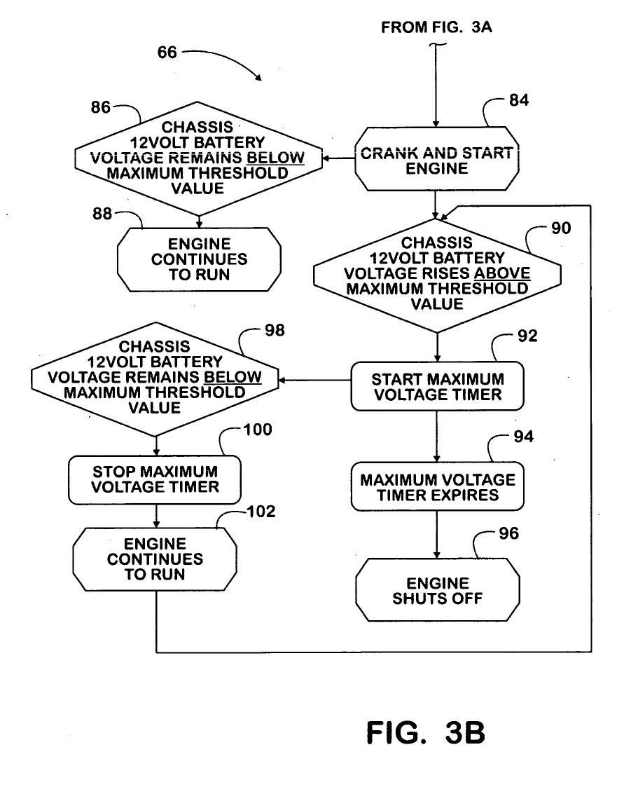

A strategy 66 for anticipating and avoiding charge depletion of battery bank 30 when alternator 32 is not delivering recharging current to it is presented in FIGS. 3A and 3B. While the strategy is intended to become active in a situation where vehicle 12 is parked with engine 14 not running and electrical accessory equipment is being supplied with current from battery bank 30, it may be come active in other situations. An example of one situation is that of the chassis being placed in the ePTO mode of operation (step 68 in FIG. 3A) that allows an electric power take-off to operate by drawing electric current from battery bank 30.

A step 70 shows that ESC 34 monitors the voltage of battery bank 30 (sometimes referred to as chassis battery voltage). As long as the monitored voltage remains above a preset minimum threshold value (sometimes referred to as a recharge initiate threshold) as determined by a step 72, then ESC 34 keeps a minimum voltage proportional timer (sometimes referred to as a recharge initiate timer) inactive and engine 14 off, as indicated by steps 74 and 76.

Should the monitored voltage become less than the preset minimum threshold value as determined by a step 78, then ESC 34 starts the minimum voltage proportional timer as indicated by a step 80. Assuming that the monitored voltage continues to remain less than the preset minimum threshold value until the timer times out after having timed a presettable recharge initiate limit (step 82), ESC 34 causes engine 14 to be cranked and started (step 84, FIG. 3B) upon timer time-out, starting alternator 32 in the process. With alternator 32 being directly connected to battery bank 30, battery bank 30 begins to be recharged by the alternator.

As long as the voltage of battery bank 30 remains less than the preset minimum threshold value (step 86), engine 14 continues to run (step 88), continuing the re-charging of battery bank 30 by alternator 32.

Should the voltage of battery bank 30, during re-charging by alternator 32, become greater than a preset maximum threshold value (step 90), then ESC 34 starts a maximum voltage timer (sometimes referred to as a recharge stop timer) (step 92). As long as the monitored voltage continues to remain greater than the preset maximum threshold value until the maximum voltage timer expires, or times out, after having timed for a preset length of time (step 94), then engine 14 is shut down upon the timer timing out (step 96), causing alternator 32 to cease recharging battery bank 30 when that happens.

Had the monitored voltage dropped to a voltage less than the maximum threshold value while the maximum voltage timer was timing (step 98), then the maximum voltage timer would have been stopped (step 100), allowing engine 14 to continue running (step 102). When the monitored voltage becomes greater than the maximum threshold value (step 90), then the maximum voltage timer is reset, and then re-started (step 92) to begin timing the preset length of time and as a consequence cause the generator to continue recharging the low-voltage battery bank until the preset length of time elapses without the monitored voltage becoming less than the maximum threshold value during timing.

Had voltage of battery bank 30 risen above the minimum threshold value (step 104) after step 80 had started the minimum voltage proportional timer, then that timer would have been stopped (step 106), and engine 14 would have remained off (step 108). Should the monitored voltage again become less than the minimum threshold value (step 78), then the minimum voltage proportional timer is reset to zero and re-started (step 80).

The ability to preset any one or more of the minimum threshold value, the recharge initiate limit, the maximum threshold value, and the length of time that the maximum voltage timer times before battery bank 30 is considered sufficiently recharged to allow continued recharging by alternator 32 allows a user to select appropriate values for the user's particular situation.

What is claimed is:

1. A hybrid electric motor vehicle comprising:
a combustion engine;
a high-voltage electrical system comprising a high-voltage battery bank;
a low-voltage electrical system comprising a low-voltage battery bank;
an electric generator driven by the engine for recharging the low-voltage battery bank;
a DC-to-DC converter for recharging the low-voltage battery bank from the high-voltage battery bank;
a monitor for indicating voltage of the low-voltage battery bank;
a recharge initiate timer that, while the high-voltage battery bank and not the generator is recharging the low-voltage battery bank via the DC-to-DC converter, is started by the monitor indicating that voltage of the low-voltage battery bank is below a recharge initiate threshold and whose rate of timing is a function of voltage indicated by the monitor as the timer times;
and wherein if the timer times to a recharge initiate limit, the generator begins recharging the low-voltage battery bank.

2. A hybrid electric motor vehicle as set forth in claim 1 in which the timer's rate of timing is a function of difference between voltage indicated by the monitor and the recharge initiate threshold.

3. A hybrid electric motor vehicle as set forth in claim 2 in which the timer's rate of timing increases with increasing difference between voltage indicated by the monitor and the recharge initiate threshold and decreases with decreasing difference between voltage indicated by the monitor and the recharge initiate threshold.

4. A hybrid electric motor vehicle as set forth in claim 1 in which once the timer has timed to the recharge initiate limit, the engine is cranked and started to cause the generator to begin recharging the low-voltage battery bank.

5. A hybrid electric motor vehicle as set forth in claim 1 in which once the generator has recharged the low-voltage battery bank to a voltage greater than a recharge stop threshold, a recharge stop timer for timing a length of time is started, and if the recharge stop timer times for the length of time without the monitored voltage becoming less than the recharge stop threshold, then the generator stops recharging the low-voltage battery bank, but if the monitored voltage becomes less than the recharge stop threshold before the recharge stop timer has timed the length of time, then the recharge stop timer is forced to re-start timing the length of time and as a consequence cause the generator to continue recharging the low-voltage battery bank until the length of time has been timed without the monitored voltage becoming less than the recharge stop threshold.

6. A hybrid electric motor vehicle as set forth in claim 5 in which each of the recharge initiate threshold, the recharge initiate limit, the recharge stop threshold, and the length of time is individually selectable.

7. A method for recharging a low-voltage battery bank of a low-voltage electrical system in a hybrid electric vehicle whose propulsion system comprises an electric motor/generator associated with a combustion engine such that at certain times during operation of the vehicle, the motor/generator recovers kinetic energy from the vehicle by operating as a generator that generates electric current for recharging a high-voltage traction battery bank in a high-voltage electrical system of the vehicle, and at other times during operation of the vehicle, the motor/generator operates as a traction motor that draws electric current from the traction battery bank to propel the vehicle either by itself, or to add additional torque to that being produced by the combustion engine, the vehicle also comprising an electric generator driven by the engine and a DC-to-DC converter through which the low-voltage battery bank is recharged by the high-voltage battery bank, the method comprising:
monitoring voltage of the low-voltage battery bank;
when the monitored voltage is below a recharge initiate threshold, while the high-voltage battery bank and not the generator is recharging the low-voltage battery bank via the DC-to-DC converter, starting a recharge initiate timer and as the timer times, controlling the timer's rate of timing as a function of monitored voltage;
and once the timer has timed to a recharge initiate limit, causing the generator to begin recharging the low-voltage battery bank.

8. A method as set forth in claim 7 in which the step of controlling the timer's rate of timing as a function of monitored voltage comprises controlling the timer's rate of timing as a function of difference between monitored voltage and the recharge initiate threshold.

9. A method as set forth in claim 8 in which the step of controlling the timer's rate of timing as a function of monitored voltage comprises increasing the timer's rate of timing with increasing difference between monitored voltage and the recharge initiate threshold and decreasing the timer's rate of timing with decreasing difference between monitored voltage and the recharge initiate threshold.

10. A method as set forth in claim 7 in which the step of causing the generator to begin recharging the low-voltage battery bank comprises causing the generator to become driven by the engine by cranking and starting the engine.

11. A method as set forth in claim 7 comprising upon the generator having recharged the low-voltage battery bank to a voltage greater than a recharge stop threshold, the further steps of starting a recharge stop timer for timing a length of time, and if the recharge stop timer times for the length of time without the monitored voltage becoming less than the recharge stop threshold, stopping the generator from recharging the low-voltage battery bank, but if the monitored voltage becomes less than the recharge stop threshold before the recharge stop timer has timed the length of time, then forcing the recharge stop timer to re-start timing the length of time and as a consequence cause the generator to continue recharging the low-voltage battery bank until the length of time has been timed without the monitored voltage becoming less than the recharge stop threshold

12. A method as set forth in claim 11 further comprising selecting a particular one of multiple possible values for one or more of the recharge initiate threshold, the recharge initiate limit, the recharge stop threshold, and the length of time.
